(19) United States
(12) Patent Application Publication
(10) Pub. No.: US 2016/0048888 A1
(43) Pub. Date: Feb. 18, 2016

(54) System and Method for Media Buying

(71) Applicant: Clifford Johnson, Seattle, WA (US)

(72) Inventor: Clifford Johnson, Seattle, WA (US)

(21) Appl. No.: 14/816,004

(22) Filed: Aug. 1, 2015

Related U.S. Application Data
(60) Provisional application No. 62/038,124, filed on Aug. 15, 2014.

(51) Int. Cl. G06Q 30/02

(52) U.S. Cl. CPC G06Q 30/0273; G06Q 30/0269

(57) ABSTRACT

A media purchase system. In the system a user receives a brief description of service at landing page, chooses a media option, selects a basic demographic, then a narrow demographic. The user views media units ranked in the order of the media unit's ability to deliver the selected demographic and user is provided the opportunity to request a reservation from the media company that operates the media unit of interest by interacting with a booking calendar.

### CROSS REFERENCE TO RELATED APPLICATIONS

This application claims priority to U.S. Provisional Patent application 62/038,124 filed Aug. 15, 2014 which is hereby incorporated by this reference as if fully set forth herein:

### TECHNICAL FIELD

This disclosure relates to systems and methods for buying advertising media.

### BACKGROUND

Media buying for advertisers is often haphazard, contrary to available market data, and time consuming.

### DISCLOSURE

A surprisingly effective new system is disclosed for advertisers to navigate the global media marketplace and purchase various media in a data-driven, information forward, online environment.

### BRIEF DESCRIPTION OF THE DRAWINGS

FIGS. 1A and 1B are a schematic flowchart of the disclosed system.

FIGS. 2-11 are schematic system screen shots.

### DETAILED DESCRIPTION

Turning now to the drawings, the disclosed system will be described by reference to the numerals of the drawing figures wherein like numbers indicate like parts.

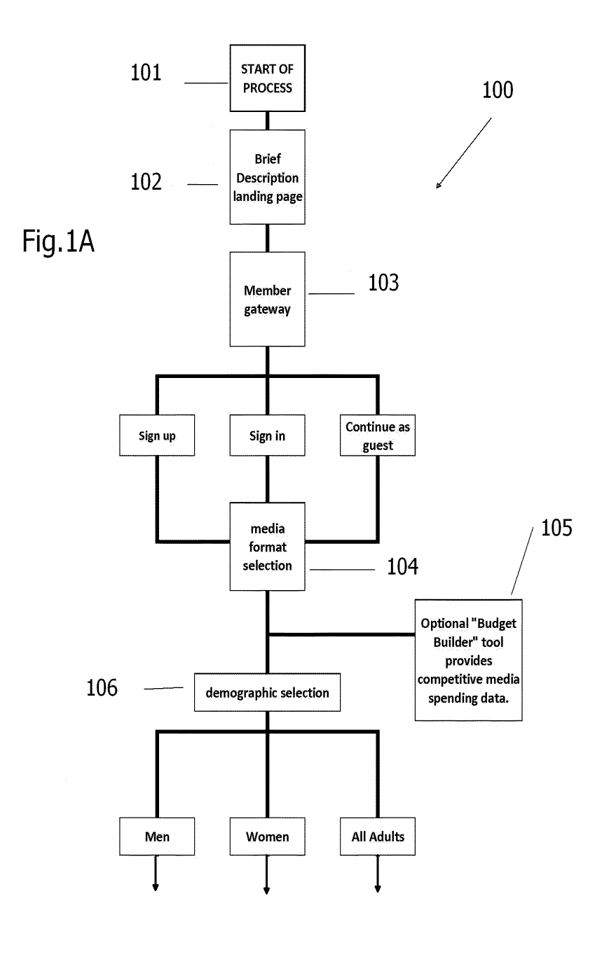

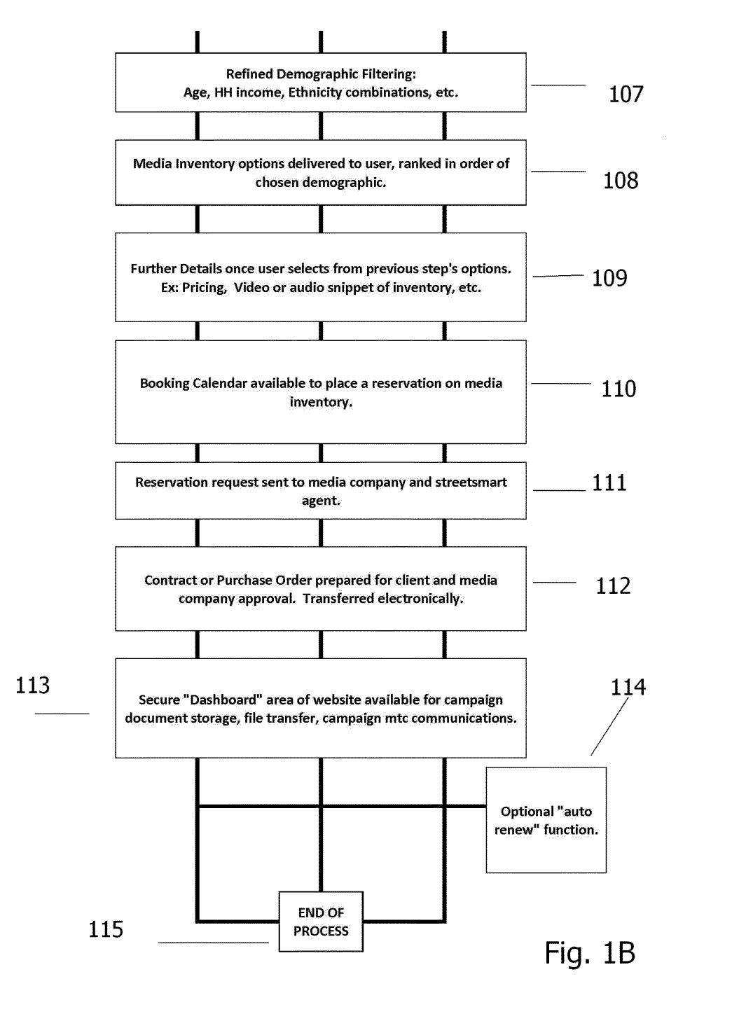

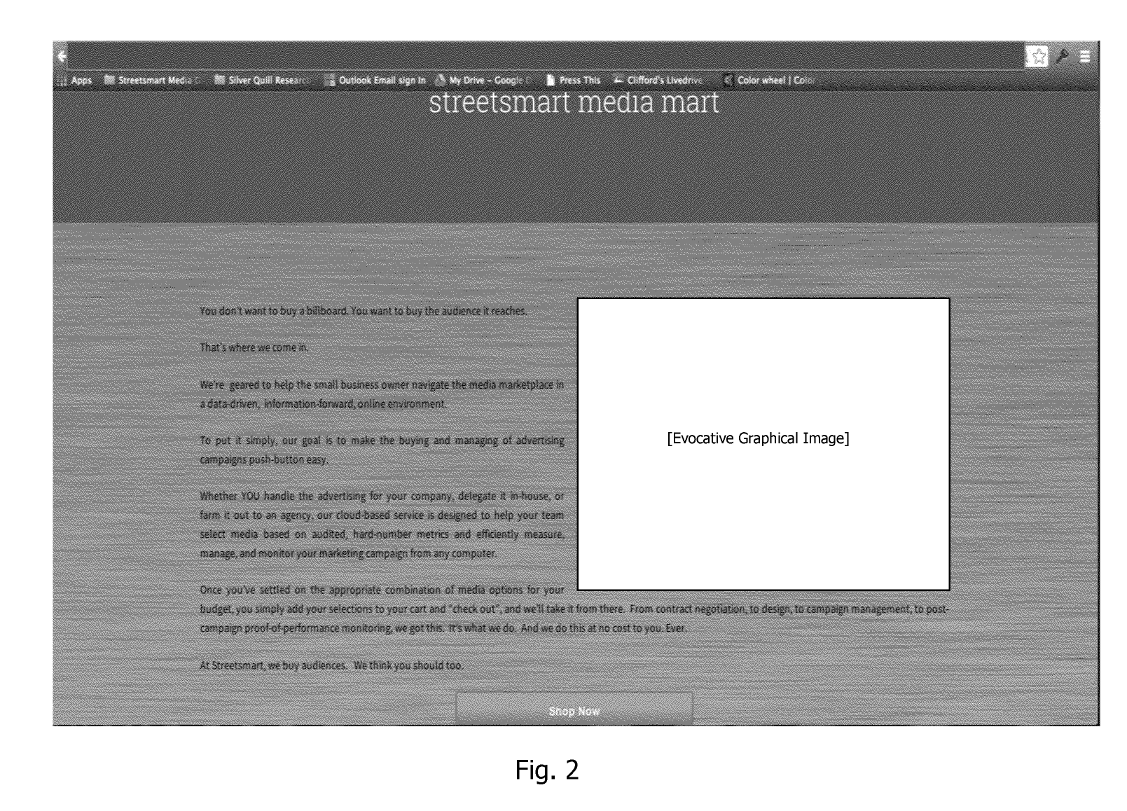

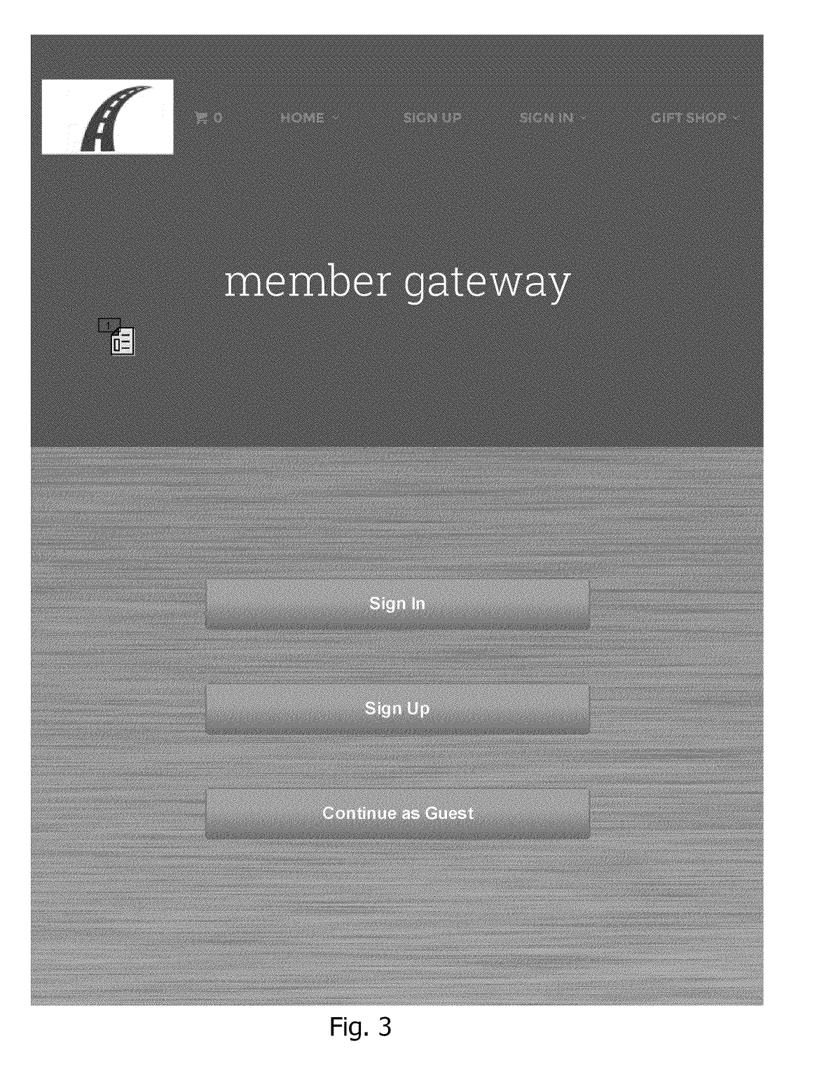

FIGS. 1A and 1B are a schematic flowchart of the disclosed system 100. User logs onto website and starts system process 101. In Step 1 (FIG. 2), the user receives a brief description of service 102 at landing page, and has the option to click “shop now” button to proceed with process. In Step 2 Membership Gateway 103 (FIG. 3), user has the option to sign up for membership in order to view a more enhanced version of processes such as pricing estimates, or historical data on competitive spending by month, year, quarter, or the like, based on their industry.

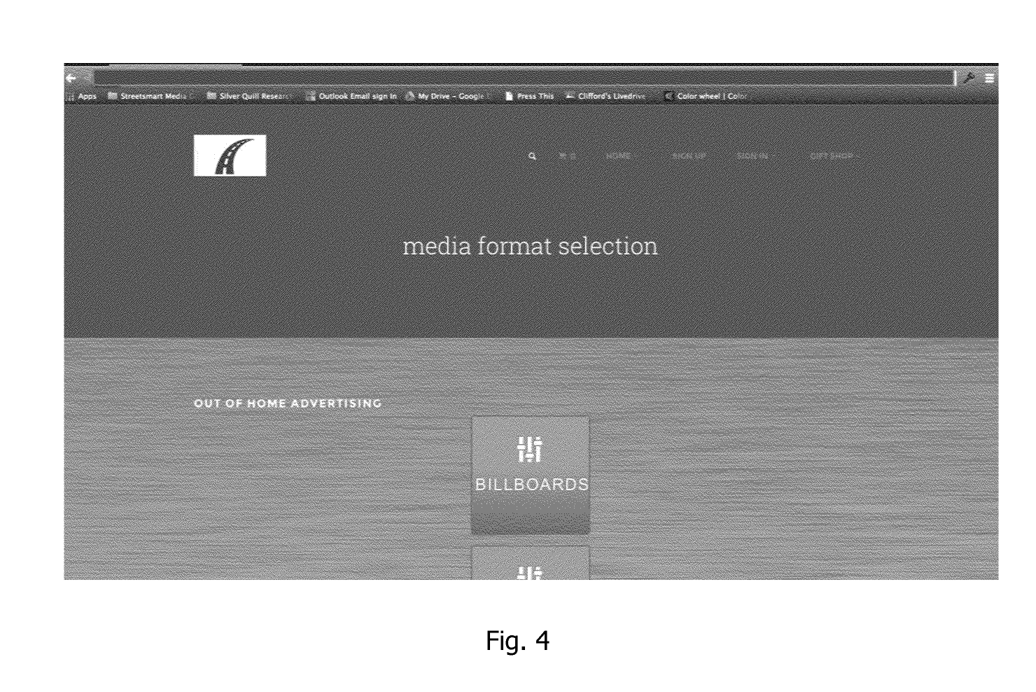

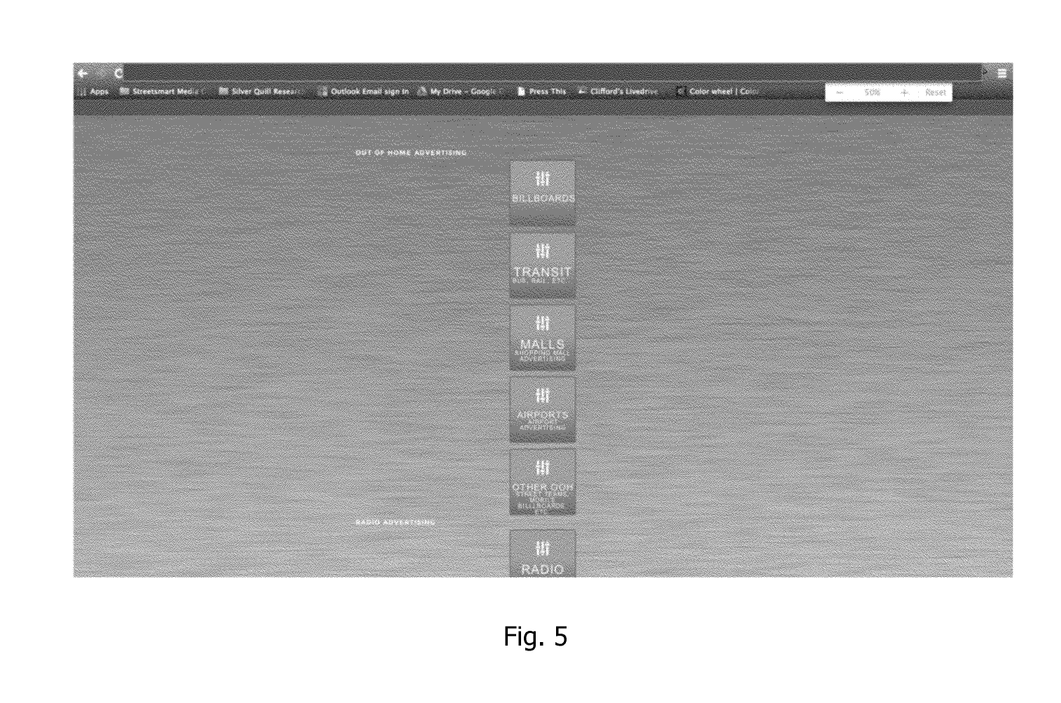

At Step 3 Media format Selection 104 (FIG. 4) user chooses from a variety of media options. Also in Optional Step 3A optional budget builder tool 105 (FIG. 5) is an optional link to a “budget builder” application wherein the user views past media spending of user's competitors in the local market broken out by media format, shown in monthly, quarterly and yearly views. This provides the user with intelligence on the degree of marketing emphasis and timing of that marketing emphasis that they can likely expect when planning their campaign so they can adjust their own marketing plan accordingly. User has option of seeing this information represented on a dollar basis or on a “percentage of advertiser spend” basis in order to put context into these numbers.

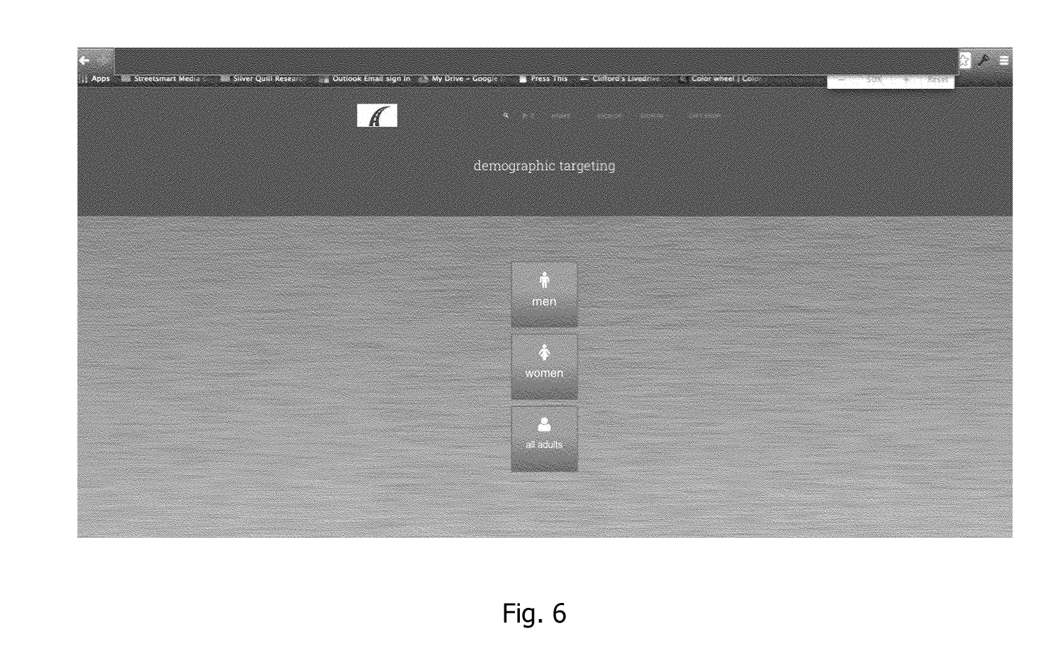

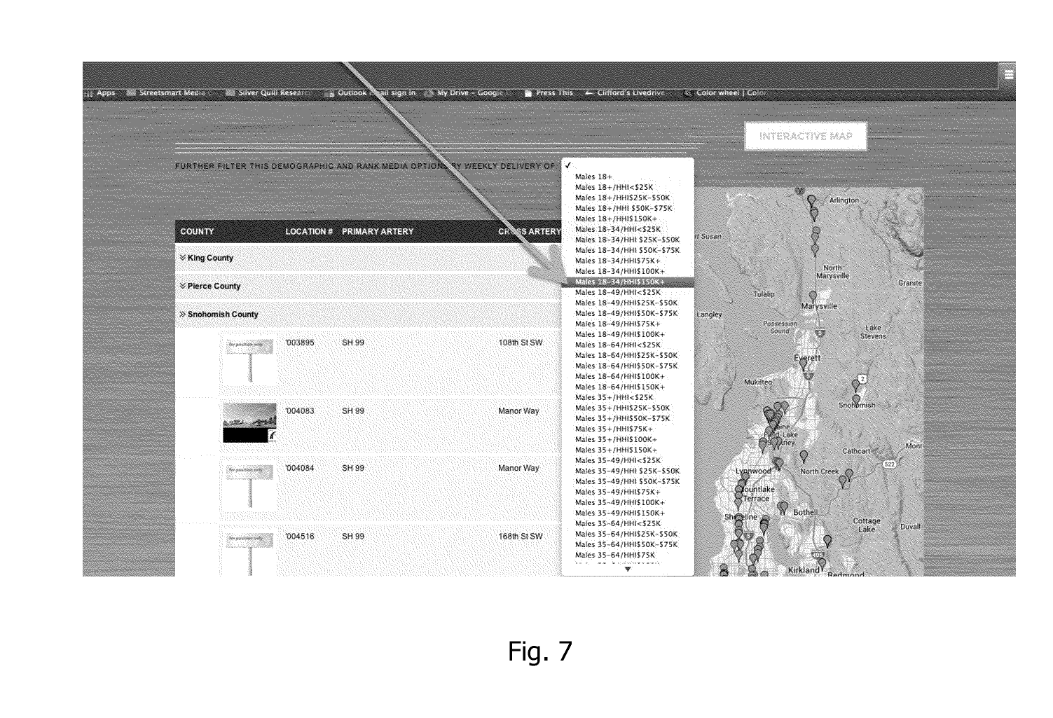

At Step 4 Target Audience Demographic selection 106 (FIG. 6), user selects among 3 basic demographics: Men, Women, or “All Adults”. User is then taken to next step for further narrowing of demographic. At Step 5 Refined Demographic Filtering 107 (FIG. 7), user selects from list of demographic combinations, which include Age, HH Income, and/or Ethnicity. Where pertinent, such as in the case of billboards, an interactive map is presented in this step. This allows the user to first sort the inventory geographically, before drilling down on the demographic delivery of the media unit. The interactive map helps to isolate a tight geography within a tightened trade zone and evaluate demographic delivery of inventory that falls within that trade zone. Once the user identifies an advertising unit of interest (for example, a billboard location), the user optionally clicks to be taken to a detail page about that media unit. Further refinement based on education, occupation type, etc, is available there.

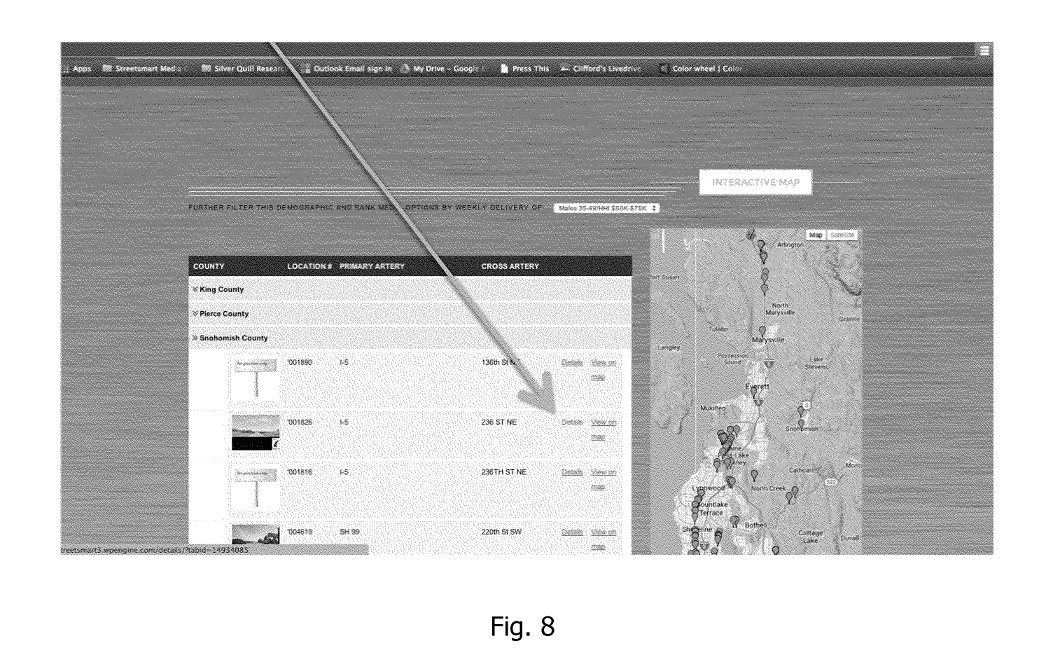

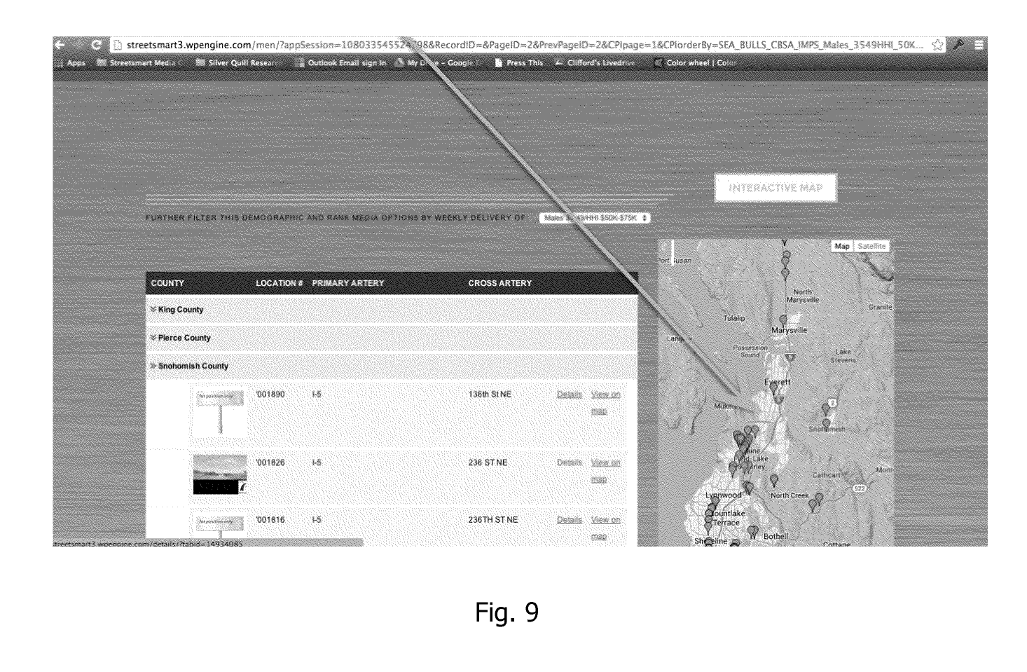

At Step 6 Media Inventory 108 (FIG. 8), user views media inventory ranked in the order of the media unit's ability to deliver the chosen demographic. User selects among inventory units. At optional Step 6A Further Details 109 (FIG. 9), user optionally gets general pricing information, ascertain the audience delivery of their specific demographic, as well as see the media unit's ability to deliver other demographics. Commonly a business has a secondary demographic, or target audience. By including a vast quantity of various demographic combinations, a user will likely find their own secondary demographic among that data.

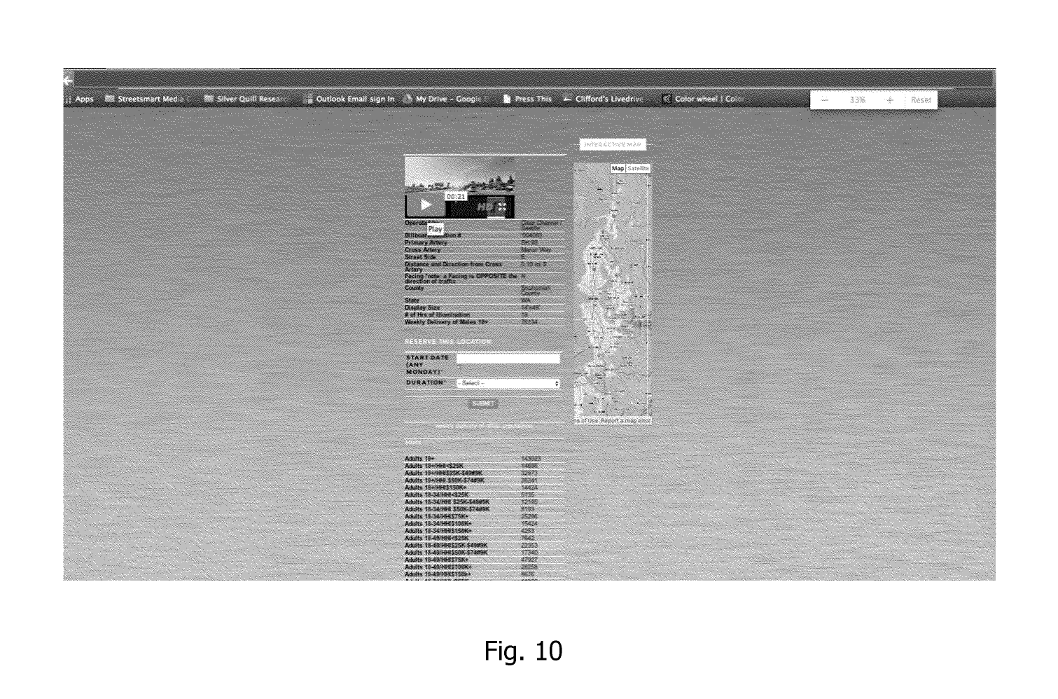

At Step 7 Booking Calendar 110 (FIG. 10), user is provided the ability to view details about the media unit of interest. Details can include video or audio snippets of said inventory, such as an approach video of a billboard, physical dimensions of the media unit, pricing fundamentals such as the time increments by which the media unit is typically offered by the media company that operates it, as well as price ranges of said unit for said increment of time Other purchase or rental details are also provided as well. Additionally, a breakout of the media unit's ability to reach other population demographics is also provided in this step. Many marketers have a secondary demographic that they market to. This additional information can be relevant in their buying decision.

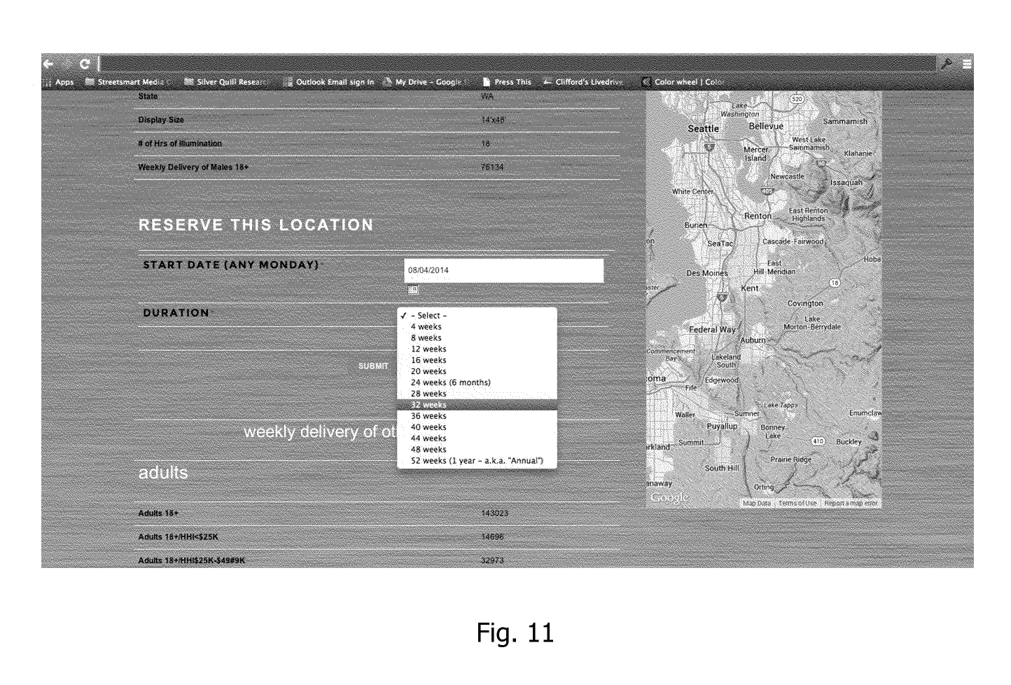

At Step 8 Reservation Request 111 (FIG. 11), user is provided the opportunity to request a reservation from the media company that operates the media unit of interest by interacting with a booking calendar. The reservations begins on the date of their choosing, and for the duration of their choosing, offered in whatever time or space increments that the media format is commonly sold in. For example, billboards are sold in what is referred to as “broadcast months” or a “broadcast calendar” wherein the year is broken into 13, 4-week increments, beginning any Monday. While a media company will certainly tailor a campaign to start and stop based on a specific advertiser's needs, the preferred system offers it on this reservation system in the typical increments that the media company prefers, as a starting point, which can be altered should the user prefer.

In Step 9 Purchase 112, the reservation request is sent electronically to media company as well as cc'd to a system agent, and a contract is prepared and submitted to user for acceptance. At Step 10 Campaign Dashboard 113, with the procurement of media time or space finalized in previous step, user has the ability to manage and monitor their campaigns via a user dashboard that acts as a secure, password protected online environment where users can communicate campaign directives, send and receive campaign instructions, approve design artwork or creative executions.

At Step 10A Optional Auto Renew 114, the user can “auto renew” their campaign which acts as a minimal click way to place an offer with the media company to renew the campaign, should inventory be available.

In an alternative embodiment of the system, the user can also select a geographic market (for example, the Seattle Market) in which they'd like to see media inventory before then selecting among media options within that market. In the step where media inventory is listed, ranked in order of delivery of chosen demographics, a user can further refine the geographic filtering to only show inventory within a certain distance of a certain location. In other words a user would be able to pull up all billboards that reach the demographic of Women 35+ making >$100K, and then also filter the results to only show billboards within 5 miles of a particular address. In the Details page/step of the process three photos of each billboard are optionally shown: a “First View, a Best View, and a Worst View”. First view is the first time a billboard is visible as a driver approaches the billboard. Best view is the best angle of the billboard (this is typically the only view that media companies provide to prospective clients). Worst View is the very worst view of the billboard, such as the part of the approach to the board that is blocked by overhanging limbs, foliage, or other obstructions. This way, the prospective buyer gets to see a unique good, bad, and ugly of what they are considering purchasing.

In compliance with the statute, the invention has been described in language more or less specific as to structural features. It is to be understood, however, that the invention is not limited to the specific features shown, since the means and construction shown comprise preferred forms of putting the invention into effect. The invention is, therefore, claimed in any of its forms or modifications within the legitimate and valid scope of the appended claims, appropriately interpreted in accordance with the doctrine of equivalents.

I claim:

1. A media purchase system for a user, the system comprising:
user receives a brief description of service 102 at landing page;
user chooses a media option;
user selects a basic demographic from the group of basic demographics consisting of Men, Women, and All Adults;
user selects a narrow demographic the group of refined demographics consisting of Age, HH Income, and Ethnicity;
user views media units ranked in the order of the media unit's ability to deliver the selected demographic;
user is provided the opportunity to request a reservation from the media company that operates the media unit of interest by interacting with a booking calendar;
the reservation request is sent electronically to the media company and copied to a system agent, and a contract is prepared and submitted to user for acceptance.
